(19) United States
(12) Patent Application Publication
(10) Pub. No.: US 2012/0090970 A1
(43) Pub. Date: Apr. 19, 2012

(54) ROTARY KNOB

(75) Inventors: Yuusuke Yoshida, Yokkaichi-city (JP); Yasushi Oonishi, Yokkaichi-city (JP); Atsushi Kosemura, Yokkaichi-city (JP)

(73) Assignee: SUMITOMO WIRING SYSTEMS, LTD., Yokkaichi-city, Mie (JP)

(21) Appl. No.: 13/259,422

(22) PCT Filed: Feb. 10, 2010
(86) PCT No.: PCT/JP2010/000836

§ 371 Date: Sep. 23, 2011

(30) Foreign Application Priority Data
Mar. 24, 2009 (JP) 2009-072092

(51) Int. Cl. H01H 9/00

(52) U.S. Cl. 200/316

(57) ABSTRACT

A rotary knob includes a knob main body body provided in a peripheral wall section with a slit, a light guide member that is fitted into the slit and includes a light emitting section and a pressure member for preventing a relative movement between the knob main body and the light guide member. The light emitting section includes a display portion that is fitted into the slit and an exposed surface and latching projections disposed inside the display portion in a radial direction and protrude outward from both sides of the slit in a width direction. The peripheral wall section includes a pair of slit peripheral edges that define the slit, and holding portions that are provided inside the slit peripheral edges and pinch the latching projections between the holding portions and the slit peripheral edges from both sides in the radial direction of the peripheral wall section.

### FIELD OF THE INVENTION

This invention relates to a rotary knob that is rotatably mounted on an operation panel or the like in a vehicle room.

### BACKGROUND OF THE INVENTION

Heretofore, a rotary knob has been known, as disclosed in Patent Document 1. The rotary knob is provided on a part of a knob main body with a light emitting section so that an operator can easily grasp an amount of rotation of the rotary knob when the operator views the light emitting section.

Specifically, as shown in FIG. 9, a conventional rotary knob 100 includes a knob main body 101 that an operator can pinch to carry out an rotary operation, and a light guide member 102 that constitutes a light emitting section. The knob main body 101 is formed into a cylindrical configuration. The knob main body 101 is provided on a portion from a distal end surface 101a to a peripheral surface 101b with a cut-out portion 103. The light guide member 102 is inserted into the cut-out portion 103. The light guide member 102 is made of a light emitting material. When lights enter the light guide member 102, the lights are diffused in the light guide member 102 and a surface on the member 102 emits the lights.

Such rotary knob 100 is mounted on an operation panel or the like for equipments. A light source or the like disposed inside the operation panel emits lights onto the light guide member 12, thereby causing the light emitting section (light guide member 102) to emit lights.

There is a case where the knob main body is required for a hollow structure or a thin cylindrical configuration in accordance with equipments on which the rotary knob is mounted. Since the knob main body in only such rotary knob is a thin cylindrical configuration, a thickness (that is, a dimension in a radial direction) of the light guide member must be thin. It is difficult to stably attach the thin light guide member to the thin knob main body. Accordingly, it is an important matter to obtain stability of the rotary knob.

### PRIOR ART DOCUMENT

### Patent Document

PATENT DOCUMENT 1: JUM SHO 62 (1987)-30189 A

### SUMMARY OF THE INVENTION

In view of the above problems, an object of the present invention is to provide a rotary knob in which a light guide member can be stabilized after being attach to a support member and can achieve a sufficient display effect.

The present invention is directed to a rotary knob that penetrates a panel from an inside of the panel and is rotatably mounted on the panel. The rotary knob comprises: a knob main body including a main body base disposed inside the panel when the rotary knob is mounted on the panel, and a cylindrical peripheral wall section that extends from the main body base to a distal end side, the knob main body being provided in a given position in a peripheral direction of the peripheral wall section with a slit that extends from a distal end of the peripheral wall section to the main body base; a light guide member including an incident section having an incident surface for lights, and a light emitting section that extends along the slit to be fitted into the slit from the incident section, a surface of the incident section being adapted to emit lights when lights enter the incident section through the incident surface; and a pressure member for pinching a part of the incident section between the main body base and the pressure member along a longitudinal direction of the slit without covering the incident surface and for preventing a relative movement between the knob main body and the light guide member in the longitudinal direction of the slit when the light emitting section is fitted into the slit. The light emitting section includes a display portion that is fitted into the slit and has an exposed surface exposed outward from the knob main body through a whole length of the slit, and latching projections that are disposed inside the display portion in a radial direction of the peripheral wall section and protrudes outward from both sides in a width direction of the slit over the display portion. The peripheral wall section includes a pair of slit peripheral edges that are opposed to each other to define the slit, and holding portions that are provided inside the slit peripheral edges in the radial direction of the peripheral wall section and pinch the latching projections between the holding portions and the slit peripheral edges from both sides in the radial direction of the peripheral wall section.

According to the present invention, it is possible to provide a rotary knob in which a light guide member can be stabilized after being attach to a support member and can achieve a sufficient display effect.

### BRIEF DESCRIPTION OF THE DRAWINGS

[FIG. 1] FIG. 1 is an exploded perspective view of a rotary knob in accordance with the present invention.

[FIG. 2] FIG. 2 is a plan view of the rotary knob shown in FIG. 1.

[FIG. 3] FIG. 3A is an end side view of a knob main body of the rotary knob taken along lines IIIA-IIIA in FIG. 1.

FIG. 3B is a longitudinal section view of the knob main body of the rotary knob taken along lines IIIB-IIIB in FIG. 1.

[FIG. 4] FIG. 4 is a rear side elevation view of the knob main body.

[FIG. 5] FIG. 5 is an end side elevation view of the rotary knob taken along a diametrical line passing through latching projections on a peripheral wall section and through a latching aperture in a main body base.

[FIG. 6] FIG. 6A is a cross section view of a pointer (a light guide member) of the rotary knob taken along lines VIA-VIA in FIG. 1. FIG. 6B is a side elevation view of the pointer shown in FIG. 6A.

[FIG. 7] FIG. 7A is a front elevation view of the rotary knob, illustrating the rotary knob disposed in an operation panel. FIG. 7B is a bottom view of the rotary knob, illustrating the rotary knob disposed in the operation panel.

[FIG. 8] FIG. 8 is an enlarged cross section view of the rotary knob taken along lines VIII-VIII in FIG. 7A.

[FIG. 9] FIG. 9 is an exploded perspective view of a prior art rotary knob.

### ASPECTS OF EMBODYING THE INVENTION

Referring now to the drawings, embodiments of a rotary knob in accordance with the present invention will be described below.

As shown in FIGS. 1 and 2, a rotary knob 10 according to an embodiment of the present invention includes a knob main body 11 that is pinched and rotated by an operator, a pointer (a light guide member) 30 that constitutes a display section for the knob main body 11, a reflection member 40 that is attached to a distal end side of the knob main body 11, and a pressure member 50 that is attached to a rear end side of the knob main body 11. The rotary knob 10 in the present embodiment is mounted on an operation panel P on a vehicle body so that the knob 10 passes through the panel P from an inner side to an outer side (see FIG. 7A to FIG. 8).

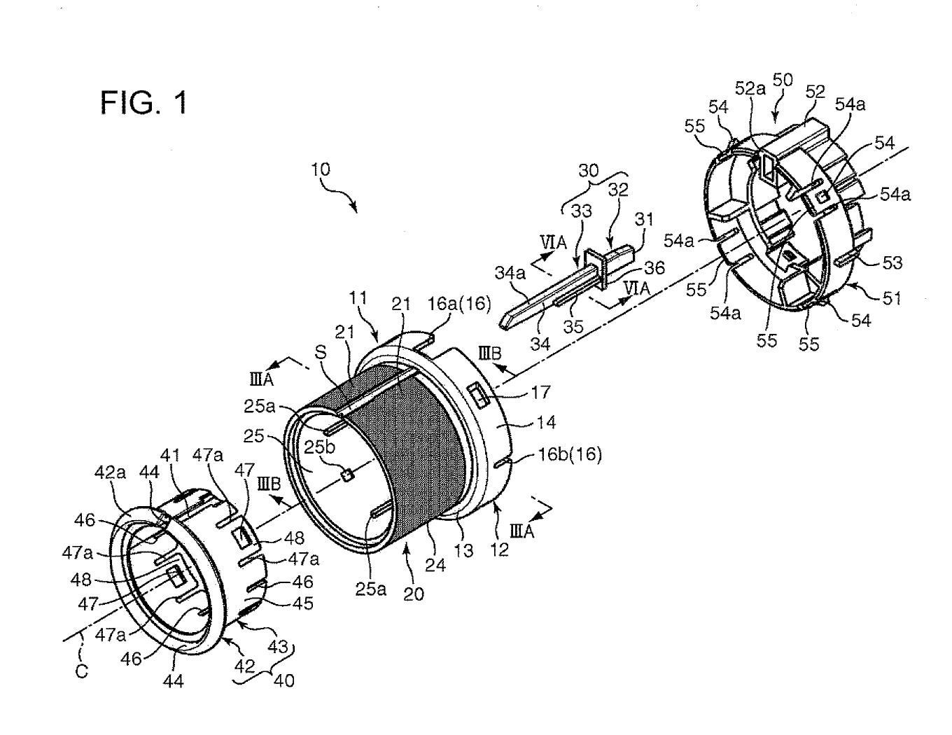

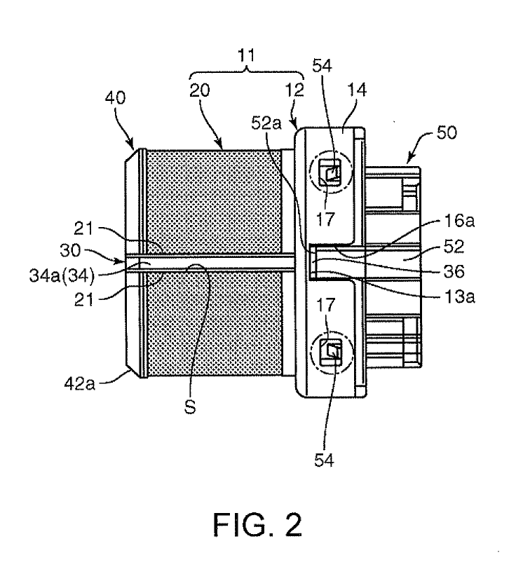

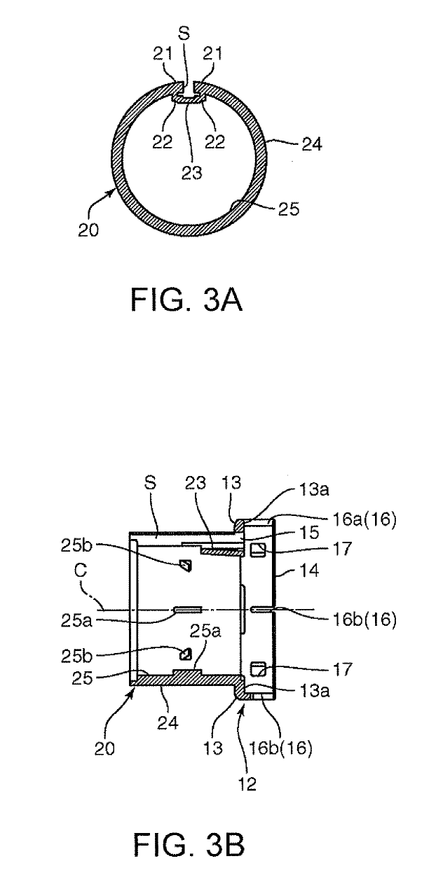

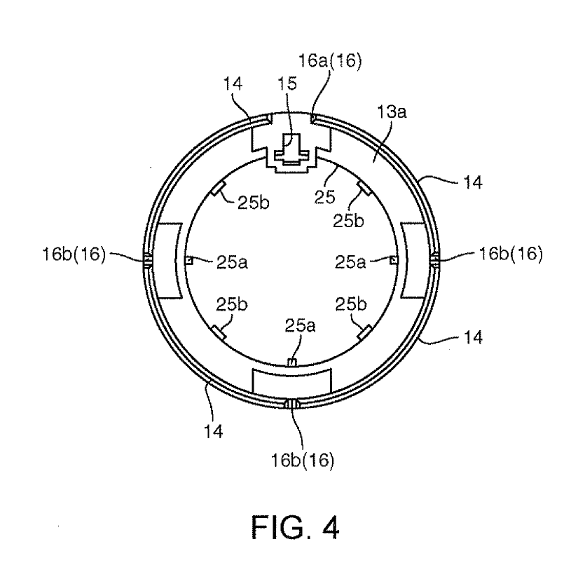

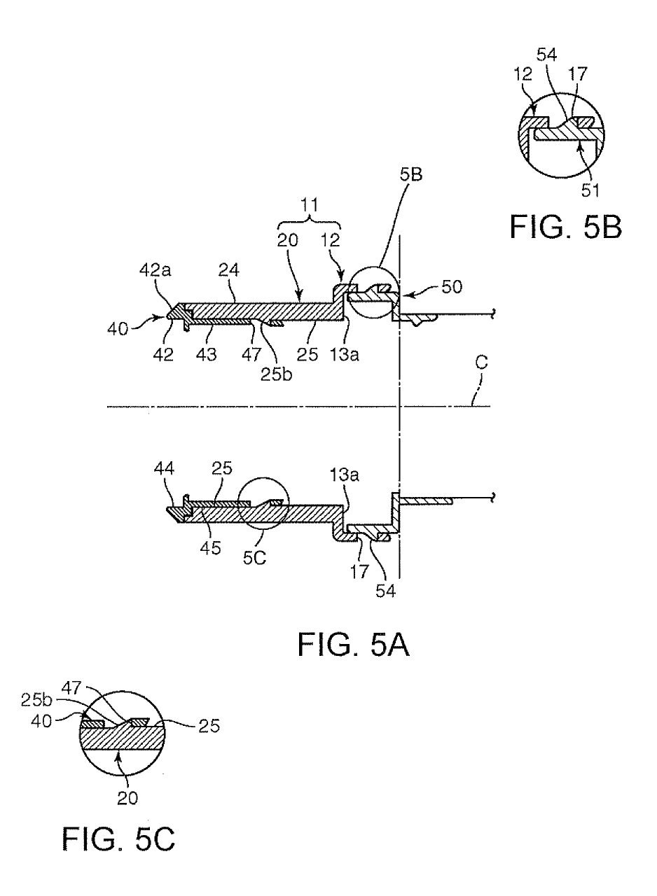

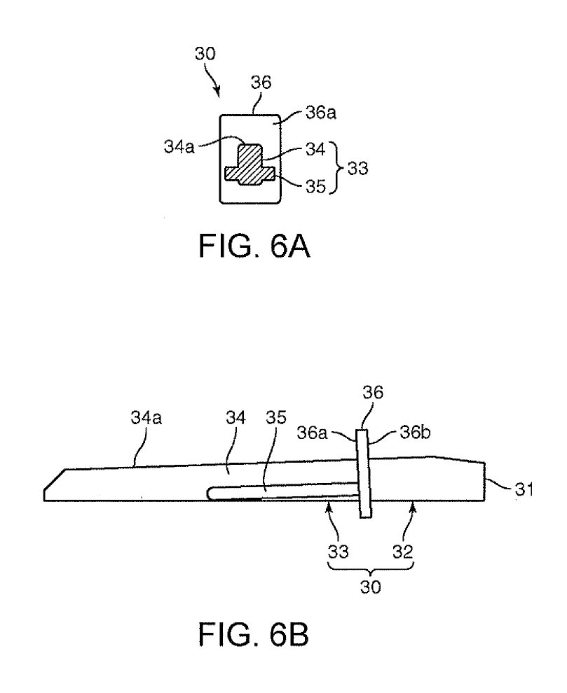

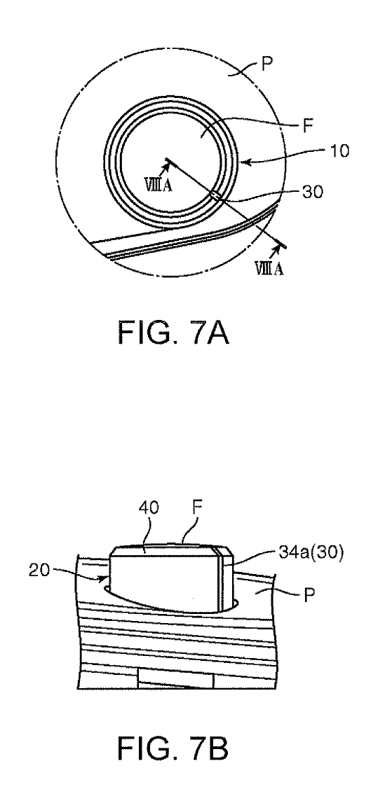

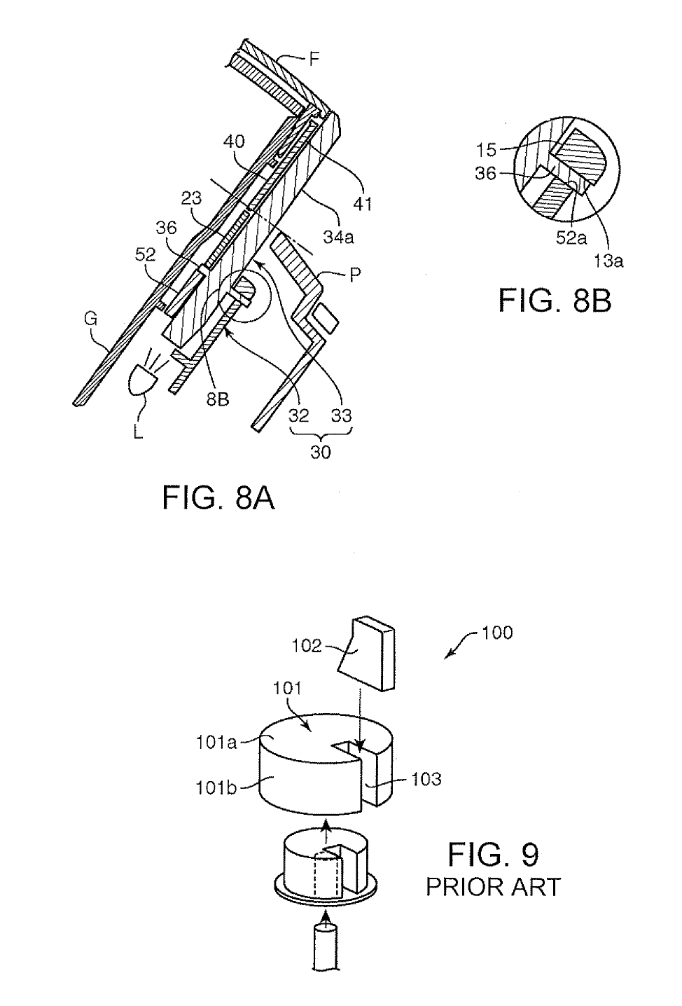

The knob main body 11 includes a main body base 12 that is located inside the operation panel P when the rotary knob 10 is mounted on the operation panel P, and a cylindrical peripheral wall section 20 that extends from the main body base 12. The peripheral wall section 20 has a cylindrical configuration having a small thickness in a radial direction (that is, a thin thickness). The peripheral wall section 20 is provided in a particular position in a circumferential direction of the wall section 20 with a slit S that extends from a distal end of the peripheral wall section 20 to the main body base 12. The slit S extends straightly so that a width of the slit S is constant from the distal end of the peripheral wall section 20 to the main body base 12. As shown in FIGS. 3A and 3B, the peripheral wall section 20 includes a pair of slit peripheral edges 21 that are opposed to each other to define the slit S, and holding portions 22 that are located inside the slit peripheral edges 21 and serve to pinch latching projections 35 (see FIGS. 6A and 6B) of the pointer 30 between the holding portions 22 and the slit peripheral edges 21 in a radial direction.

As shown in FIG. 3A, the holding portions 22 protrude downward from the slit peripheral edges 21 on an inner peripheral surface 25 of the peripheral wall section 20. Distal ends of the holding portions 22 are bent toward each other. The distal ends of holding portions 22 across the slit S are coupled to each other by a reinforcement portion 23. That is, the reinforcement portion 23 connects the holding portions 22 to each other across the slit S. The reinforcement portion 23 is formed into a plate-like configuration and is located on only an area at an inner part from a front surface of the operation panel P when the rotary knob 10 is mounted on the operation panel P (see FIG. 8). In the present embodiment, the slit peripheral edges 21, holding portions 22, and reinforcement portion 23 are integrally molded. However, the peripheral wall section 20 is not limited to the above structure. After the slit peripheral edges 21, holding portions 22, and reinforcement portion 23 are formed individually, they may be connected to one another. In the present embodiment, the words “distal end side” mean a direction that protrudes from the operation panel P (an upper side in FIG. 7B) when the rotary knob 10 is mounted on the operation panel P. The words “radial direction” mean a diametrical direction on the peripheral wall section 20 of the knob main body 11.

An anti-slip treatment is applied to an outer peripheral surface 24 of the peripheral wall section 20. In the present embodiment, the outer peripheral surface 24 is worked by a knurling process as the anti-slip treatment. The peripheral wall section 20 is provided on the inner peripheral surface 25 with a plurality of ridges 25a (see FIG. 33) that extend along a central axis C of the peripheral wall section 20. As shown in FIG. 4, the ridges 25a are spaced from one another in the circumferential direction of the inner peripheral surface 25. In the present embodiment, three ridges 25a are provided on the inner peripheral surface 25. The peripheral wall section 20 is provided on the inner peripheral surface 25 with a plurality of latching projections 25b that protrude inward from the inner peripheral surface 25 to the center in the radial direction. Each of the latching projections 25b is located on the inner peripheral surface between the adjacent ridges 25a spaced from each other in the circumferential direction of the inner peripheral surface 25. The ridges 25a and latching projections 25b are used when a reflection member 40 is attached to the knob main body 11. The ridges 25a serve to guide the reflection member 40 in an inserting direction when the reflection member 40 is inserted into the peripheral wall section 20. The latching projections 25b serve to latch the reflection member 40 in the knob main body 11 (see FIG. 5).

As described above, the main body base 12 is located inside the operation panel P, when the rotary knob 10 is mounted on the operation panel P. An outer diameter of the main body base 12 is larger than that of the peripheral wall section 20. Specifically, the main body base 12 includes a vertical annular portion 13 that extends upward from a rear end of the peripheral wall section 20 (an end at a side of the main body base 12), and engagement section 14 that extends radially from an outer peripheral edge of the vertical annular portion 13 at a rear side of the portion 13 (see FIG. 4).

The vertical annular portion 13 is provided on an end opposite from the peripheral wall section 20 (that is, a rear end) with a rear end surface 13a that extends along a surface perpendicular to the central axis C. The rear end surface 13a is an annular surface taken from a rear side. The rear end surface 13a is provided in a position corresponding to the slits S in the peripheral wall section 20 with a pointer insertion aperture 15.

The pointer insertion aperture 15 is a through-hole that extends along the slits S to receive a light emitting section 33 of the pointer 30 and that is defined by an inner peripheral surface corresponding to the outer peripheral surface of the light emitting section 33 when the pointer 30 is attached to the knob main body 11 (see FIG. 4 and FIG. 6A).

The engagement section 14 is formed into a short tubular configuration that extends backward from the outer peripheral edge of the vertical annular portion 13 in parallel to the peripheral wall section 20. The engagement section 14 serves to latch the pressure member 50 when it is attached to the knob main body 11. The engagement section 14 is provided with a plurality of cut-out portions 16 spaced apart one another in a circumferential direction of the portion 14. The cut-out portions 16 are spaced apart from one another by equal distances in the circumferential direction. Four cut-out portions 16 are provided in the present embodiment. Each cut-out portion 16 is formed forward from a rear end of the engagement section 14. A width of the cut-out portion 16a located in a position corresponding to the slit S in the circumferential direction is broader than widths of the other three cut-out portions 16b. The width of the broader cut-out portion 16a corresponds to a width of a flange portion 36 (see FIG. 6A) of the pointer 30. The engagement section 14 is provided in its peripheral position with a plurality of latching apertures 17. Each latching aperture 17 penetrates the engagement section 14 in the radial direction. The latching apertures 17 are spaced apart from one another by an equal distance in the circumferential direction of the engagement section 14. Specifically, each latching aperture 17 is located between the adjacent cut-out portions 16 spaced apart from each other. In the present embodiment, four latching apertures 17 are provided in the engagement section 14.

The pointer 30 is formed into a bar-like configuration that extends along the slit S. A dimension in height of the pointer 30 in the radial direction is substantially the same as that of the peripheral wall section 20, that is, it is thin. Specifically, as shown in FIGS. 6A and 6B, the pointer 30 includes a pointer base (an incident section) 32 having an incident surface 31 for light, and a light emitting section 33 that extends along the slit S so that the pointer 30 can be fitted into the slit S from the pointer base 32 and that emits lights from a surface on the light emitting section 33 when lights enter the pointer base 32. The light emitting section 33 includes a display portion 34 having an exposed surface 34a that is fitted in the slit S and is exposed outward from the knob main body 11 through a whole length of the slit S, and latching projections 35 that are disposed inside the display portion 34 in the radial direction and that contains parts protruding outward at both sides of the slit S in its width direction. The pointer 30 in the present embodiment has a length in which a distal end of the light emitting section 33 protrudes over a distal end of the peripheral wall section 20 when the pointer 30 is attached to the knob main body 11.

The display portion 34 is fitted into the slit S. That is, the display portion 34 is fitted in a gap between the pair of slit peripheral edges 21 on the peripheral wall section 20. The exposed surface 34a that emits lights when lights enter the pointer base 32 is disposed at an outer side in the radial direction of the peripheral wall section 20. The display portion 34 in the present embodiment is formed into a rectangular shape in cross section and is provided on an outer end in the radial direction (on an upper side in FIG. 6A) with the exposed surface 34a. The exposed surface 34a is coplanar to the outer peripheral surface 24 of the peripheral wall section 20 of the knob main body 11 when the display portion 34 is fitted into the slit S (see FIG. 7B). A distal end of the exposed surface 34a is inclined downward (see FIG. 6B). An inclination angle of the slant part of the exposed surface 34a corresponds to that of a chamfer section 42 (see FIG. 1) of the reflection member 40 (see FIG. 7B). Since the distal end of the exposed surface 34a is inclined downward, it is easy for an operator to view a position of the exposed surface 34a from a front side of the rotary knob 10 (see FIG. 7A).

The latching projections 35 are located inside the display portion 34 in the radial direction and extend along the display portion 34. Specifically, the latching projections 35 are disposed inside the display portion 34 and widen in a width direction of the slit S (in right and left directions in FIG. 6A). The latching projections 35 is located at a side of the pointer base 32 on the light emitting section 33. In the present embodiment, the latching projections 35 extend from a substantially central part of the light emitting section 33 in its longitudinal direction toward the pointer base 32. Specifically, parts of the latching projections 35 that protrude over the display portion 34 in the width direction of the slit S are formed into plate-like configurations each having a constant thickness from the substantially central part of the light emitting section 33 in its longitudinal direction toward the pointer base 32. That is, when the pointer 30 is attached to the knob main body 11, the parts of the latching projections 35 that protrude over the display portion 34 in the width direction of the slit S are located in spaces (see FIG. 3A) defined between the slit peripheral edges 21 of the peripheral wall section 20 and the holding portions 22 corresponding to the slit peripheral edges 21 and are formed into configurations corresponding to the spaces. The parts of the latching projections 35 that protrude over the display portion 34 in the width direction of the slit S must not be continuous in the longitudinal direction of the slit S and they may be discontinuously arranged.

The pointer base 32 is provided on a rear end side of the light emitting section 33 and includes an incident surface 31 and a flange portion 36. The pointer base 32 is integrated with the light emitting section 33. The incident surface 31 is provided on a rear end of the pointer base 32 and is perpendicular to the longitudinal direction of the slit S. The flange portion 36 widens outward from a periphery of the pointer base 32 in the radial direction. A front side surface 36a of the flange portion 36 is formed into a configuration that extends along a peripheral edge around the pointer insertion aperture 15. Specifically, the flange portion 36 is a rectangular plate taken from a front side. The front side surface 36a is a flat shape perpendicular to the longitudinal direction of the slit S. A rear side surface 36b of the flange portion 36 is a flat shape perpendicular to the longitudinal direction of the slit S.

The pointer 30 constructed above is inserted into the pointer insertion aperture 15 in the main body base 12 from a distal end of the pointer 30 to be attached to the knob main body 11. Specifically, the pointer 30 is inserted into the pointer insertion aperture 15 until the front side surface 36a of the flange portion 36 contacts the rear end surface 13a of the main body base 12. Then, an end at the side of the pointer base 32 of the light-emission 33 is disposed in the pointer insertion aperture 15. The parts that protrude outward from both sides of the latching projections 35 in the width direction of the slit S are pinched between the slit peripheral edges 21 and the holding portions 22 corresponding to the slit peripheral edges 21. The display portion 34 is fitted into a space (that is, the slit S) between the pair of slit peripheral edges 21 (see FIG. 2, and FIGS. 7A and 7B). At this time, the whole front side surface 36a on the flange portion 36 of the pointer base 32 contacts the peripheral edge around the pointer insertion aperture 15 in the rear side surface 13a of the main body base 12. When the outer end of the flange portion 36 in its radial direction is fitted into the wide slit 16a in the engagement section 14, the front side surface 36a of the flange portion 36 contacts the rear side surface 13a of the main body base 12 (see FIG. 2, and FIGS. 7A and 7B).

The reflection member 40 is formed into a cylindrical shape and is fitted into the peripheral wall section 20 of the knob main body 11 except a front end of the member 40 (see FIG. 5). The reflection member 40 has a reflection surface 41. Specifically, the reflection member 40 includes an end chamfer section 42 and a first cylindrical fitting section 43 that extends backward from the end chamfer section 42 to be fitted into the peripheral wall section 20. The first cylindrical fitting section 43 is provided with the reflection surface 41. The end chamfer section 42 is located at a distal end side of the first cylindrical fitting section 43 of the reflection member 40 and is provided with an slant surface 42a that inclines inward from the distal end of the reflection member 40 in its radial direction (see FIG. 1). The reflection member 40 is provided at a position corresponding to the slit S in the peripheral wall section 20 with a cut-out portion 44. The cut-out portion 44 has a width enough to receive the distal end of the pointer 30, that is, a distal end of the light emitting section. 33. The distal end of the light emitting section 33 that protrudes forward from the peripheral wall section 20 is fitted into the cut-out portion 44. At this time, they are smoothly coupled to each other since the slant surface on the distal end of the exposed surface 34a on the light emitting section 33 has the same slant angle as that of the slant surface 42a on the chamfer section 42 (see FIG. 7B). A lid member F (see FIG. 7A to FIG. 8) is fitted into an opening 44 surrounded by the chamfer section 42 to close the opening 44, when the rotary knob 10 is mounted on the operation panel P.

The first cylindrical fitting section 43 has an outer peripheral surface 45 (see FIG. 5) corresponding to the inner peripheral surface 25 of the peripheral wall section 20. The first cylindrical fitting section 43 has a length in the central axis C in such a manner that the portion 43 contacts the distal end of the reinforcement portion 23 or it is spaced apart from the distal end with a slight clearance. The first cylindrical fitting section 43 is provided on its outer peripheral surface 45 at a position corresponding to the slit S with the reflect surface 41. The reflection surface 41 is located inside the light emitting section 33 in the radial direction and outside the reinforcement portion 23 at the distal end side. The reflection surface 41 is opposed to the light emitting section 33 to reflect the lights from the light emitting section 33. In the present embodiment, a whole surface of the reflection member 40 including the reflection surface 41 is treated with chromium plating in order to enhance an efficiency in reflection of lights.

The first cylindrical fitting section 43 is provided in positions corresponding to the latching ridges 25a provided on the inner peripheral surface 25 of the peripheral wall section 20 with cut-out portions 46 that extend along the latching ridges 25a. The latching ridges 25a on the inner peripheral surface 25 of the peripheral wall section 20 enter the cut-out portions 46 to be straightly guided backward along the latching ridges 25a, when the first cylindrical fitting section 43 is inserted into the peripheral wall section 20.

The first cylindrical fitting section 43 is provided in positions corresponding to the latching projections 25b on the inner peripheral surface 25 of the peripheral wall section 20 with latching apertures 47. The latching apertures 47 penetrate the portion 43 in the radial direction. The first cylindrical fitting section 43 is provided in both sides of the latching apertures 47 in the circumferential direction with latching cut-out portions 47a that extend from a rear end to a front end. Each latching cut-out portion 47a forms a tongue piece portion 48 of which a rear end is a free end on a peripheral edge around each latching aperture 47. Since the tongue piece portion 48 is formed in such manner, a rear end of the tongue piece portion 48 enable the latching projection 25b to pass forward while the rear end of the tongue piece portion 48 is deflected inward in the radial direction, when the first cylindrical fitting section 43 is inserted into the peripheral wall section 20. Then, when the tongue piece portions 48 return to the original position, the latching projections 25b on the peripheral wall section 20 are engaged with the latching apertures 47 in the reflection member 40 (see FIG. 5). Thus, the reflection member 40 is engaged with the knob main body 11.

Since a pressure member 50 cooperates with the main body base 12 to pinch a part of the pointer base 32 in the longitudinal direction of the slit S, it is possible to prevent the knob main body 11 and pointer 30 from being displaced from each other in the longitudinal direction of the slit S. Specifically, as shown in FIGS. 2 and 8, the pressure member 50 pinches the flange portion 36 of the pointer base 32 between the main body base 12 and the pressure member 50 so that the pressure member 50 presses the flange portion 36 of the pointer base 32 onto the rear end surface 13a on the main body base 12. At this time, the pressure member 50 can press the flange portion 36 onto the main body base 12 without covering the incident surface 31 on the pointer main body 32.

Specifically, the pressure member 50 is formed into a short tubular configuration. The pressure member 50 includes a second fitting section 51 that can be fitted into the engagement section 14 of the main body base 12, and a pressure portion 52 that cooperates with the main body base 12 to pinch the flange portion 36 of the pointer 30. The second fitting section 51 has an outer peripheral surface corresponding to the inner peripheral surface of the engagement section 14 of the main body base 12. The second fitting section 51 is provided on its outer peripheral surface at positions corresponding to the narrow cut-out portions 16b provided in the engagement section 14 with projecting ridges 53 that extend along the cut-out portions 16b. The projecting ridges 53 enter the cut-out portions 16b, when the second projecting ridge 51 is inserted into the engagement section 14. Consequently, the pressure member 50 can be guided straightly into the knob main body 11 without rotating in the knob main body 11.

The second fitting section 51 is provided on its peripheral surface at positions corresponding to the latching apertures 17 in the engagement section 14 of the main body base 12 with latching projections 54. The second fitting section 51 is provided in both sides of each latching projection 54 in the peripheral direction with latching cut-out portions 54a that extend from a front end to a rear end. The latching cut-out portions 54a form a tongue piece portion 55 of which a rear end is a free end on a peripheral edge around each latching projection 54. Since the tongue piece portion 55 is formed in such manner, the latching projections 54 on the tongue piece portions 55 contact the inner surface of the engagement section 14, when the second fitting section 51 is inserted into the cylindrical engagement section 14. Thus, the latching projections of the tongue piece portions 55 reach the latching apertures 17 in the engagement section 14 while front ends of the tongue piece portions 55 are deflected. Then, the tongue piece portions 55 return to the original position. Thus, the latching projections 54 on the pressure member 50 are engaged with the latching apertures 17 in the engagement section 14 (see FIGS. 2 and 5). Consequently, the pressure member 50 is engaged with the knob main body 11.

The pressure portion 52 is provided on the pressure member 50 at a position corresponding to the pointer base 32 of the pointer 30. The pressure portion 52 surrounds the pointer base 32 that protrudes backward from the rear end surface 13a of the main body base 12. Specifically, the pressure portion 52 is formed into a tubular shape that surrounds the pointer base 32. The pressure portion 52 is provided on its distal end with a pressure surface 52a that pinches the flange portion 36 of the pointer 30 between the pressure surface 52a and the main body base 12 (specifically, a peripheral edge around the pointer insertion aperture 15 in the rear end surface 13a).

The pressure surface 52a is perpendicular to the central axis C and is formed into a frame-like configuration. The pressure member 52 pinches the flange portion 36 between the pressure surface 52a and the rear end surface 13a so that the pressure surface 52a presses the flange portion 36 onto the rear end surface 13a when the pressure surface 52a surrounds the pointer base 32. Specifically, when the second fitting section 51 of the pressure member 50 is inserted into the engagement section 14 and the latching projections 54 on the second fitting section 51 are engaged with the latching apertures 17 in the engagement section 14 of the main body base 12, the flange portion 36 is pinched between the peripheral edge around the pointer insertion aperture 15 in the rear end surface 13a and the pressure surface 52a without causing any clearance in the front and rear directions (see FIGS. 2 and 8).

At this time, since the pressure portion 52 is formed into the tubular shape that extends in front and rear directions, the rear end of the pointer 30 (that is, the incident surface 31 on the pointer base 32) is not covered by the pressure portion 52 to be a free open end (see FIG. 8).

As shown in FIGS. 7A and 7B, the rotary knob 10 constructed above is located on the operation panel P in the vehicle room so that a front end side of the peripheral wall section 20 protrudes from the aperture provided in the operation panel P. At this time, as shown in FIG. 8, the lid member F is fitted into the opening 44 in the reflection member 40 and a rotary shaft G is inserted into the hollow rotary knob 10. The rotary knob 10 can rotate about the rotary shaft G. A light source L is disposed in the rotary knob 10 at a position opposed to the incident surface 31 at a rear end of the pointer base 32. When the rotary knob 10 is turned, the light source L is turned with the incident surface 31 to be always opposed to the incident surface 31. That is, the light source L is located in the rotary knob so that the light source L can always emits lights toward the incident surface 31 even if the rotary knob 10 is turned. Since the lights from the light source L enter the pointer base 32 through the incident surface 31, the lights are diffused in the pointer 30 to illuminate the exposed surface 34a on the light emitting section 33.

According to the rotary knob 10 described above, it is possible to settle the pointer 30 in the knob main body 11 and to effect a sufficient display effect after the pointer 30 is attached to the knob main body 11, even if the peripheral wall section 20 of the knob main body 11 is thin.

Even if the peripheral wall section 20 and the pointer 30 to be attached to the peripheral wall section 20 are thin, it is possible to pinch the display portion 34 on the pointer 30 in the width direction of the slit S by utilizing the pair of slit peripheral edges 21 of the knob main body 11 and it is possible to stably attach the pointer 30 to the knob main body 11 by pinching the latching projections 35 on the pointer 30 from the radial direction of the peripheral wall section 20.

Specifically, the pair of slit peripheral edges 21 pinch the display portion 34 in the width direction of the slit S, and the slit peripheral edges 21 and the holding portions 22 located inside the slit peripheral edges 21 in the radial direction pinch the latching projections 35 in the radial direction. Consequently, it is possible to effectively prevent the light emitting section 33 from fluttering in the slit S in the width direction and in the radial direction. Under this condition, since the main body base 12 and pressure member 50 pinch the flange portion 36 of the pointer base 32 in the longitudinal direction of the slit S (see FIG. 2), it is possible to prevent the pointer base 32 from sliding in the main body base 12 in the longitudinal direction of the slit S. Thus, it is possible to prevent a relative movement between the knob main body 11 and the pointer 30 in the longitudinal direction of the slit S, thereby settling the pointer 30 in the knob main body 11. The latching projections 35 are pinched at the rear side of the slit peripheral edges 21. When the rotary knob 10 is mounted on the operation panel P, the exposed surface 34a on the display portion 34 of the light emitting section 33 can be exposed outward over the whole length of the slit S at the peripheral wall section 20 that protrudes from the front surface of the operation panel P (see FIG. 7B). Consequently, it is possible for the light emitting section 33 to carry out a sufficient display effect by illuminating the whole exposed surface 34a by the lights from the light source L to the incident surface 31 while holding the light emitting section 33 stably.

In the present embodiment, since the reinforcement portion 23 that couples the holding portions 22 to each other across the slit S is provided on the peripheral wall section 20, the knob main body 11 in which the slit S is provided in the peripheral wall section 20 can be effectively reinforced. Furthermore, when the rotary knob 10 is disposed to penetrate the operation panel P from the inside, the reinforcement portion 23 is located in only an inner area from the front surface of the operation panel P. When the exposed surface 34a on the display portion 34 emits the lights, the reinforcement portion 23 hardly affects the light emitting action from the exposed surface 34a at the front surface of the operation panel P. That is, even if an uneven light emitting action is caused on the exposed surface 34a on account of a difference in reflection coefficient of light under a condition inside the light emitting section 33 in the radial direction, that is, under positions on where the reinforcement portion 23 is provided and is not provided, the position that causes the uneven light emitting action is located inside the operation panel P, thereby preventing the uneven light emitting action or the like from appearing on the front surface of the operation panel P.

Since the reflection member 40 is located inside the light emitting section 33 in the radial direction and is located at a distal end side over the reinforcement portion 23, the exposed surface 34a becomes brighter, thereby enabling the display portion 34 to achieve a sufficient display effect. This can be caused because, when the rotary knob 10 is mounted on the operation panel P and the lights that enter the projecting portion from the operation panel P through the incident surface 31 come out from the light emitting section 33 to the inside in the radial direction, the lights are reflected on the reflection surface 41 of the reflection member 40 opposed to the light emitting section 33 so as to be directed outward in the radial direction.

Since the flange portion 36 of the pointer 30 is pressed by the rear end surface 13a of the main body base 12 when the pointer 30 is attached to the knob main body 11, the distal end surface 36a of the flange portion 36 contact the peripheral edge around the pointer insertion aperture 15 in the rear end surface 13a, thereby settling the pointer 30 in the knob main body 11. That is, since the flange portion 36 that widens in a direction perpendicular to or substantially perpendicular to the extending direction of the light emitting section 33 is pressed by the rear end surface 13a when the flange portion 36 contact the rear end surface 13a through the whole peripheral length around the pointer insertion aperture 15, it is possible to suitably prevent the distal end of the light emitting section 33 from fluttering in the knob main body 11.

It should be noted that the rotary knob of the present invention is not limited to the above embodiment. The present invention can include various alterations without departing the gist of the present invention.

Although the peripheral wall section 20 in the above embodiment is formed into a cylindrical configuration having a constant diameter at the respective positions in the direction of the central axis C, this is not limited. The peripheral wall section 20 may be formed into a peripheral wall section having a peripheral surface of a circular truncated cone that reduces a diameter toward the distal end. The peripheral wall section may not be a cylindrical configuration but a polygonal configuration.

Although the exposed surface 34a of the pointer 30 in the above embodiment is formed to be coplanar with the outer peripheral surface 24 of the peripheral wall section 20, this is not limited. That is, the exposed surface 34a may bulge its central part in the width direction to form a projection along the slit S. Also, the exposed surface 34a may depress its central part in the width direction to form a groove along the slit S. Since the exposed surface 34a can emits lights over the entire length of the slit S at the position on the peripheral wall section 20 that protrudes outward from the front surface of the operation panel P, even if the exposed surface 34a is formed into the above configurations, the exposed surface 34a can achieve a sufficient display effect.

The embodiments described above can be summarized as follows.

The rotary knob in the present embodiments penetrates a panel from an inside of the panel and is rotatably mounted on the panel. The rotary knob comprises: a knob main body including a main body base disposed inside the panel when the rotary knob is mounted on the panel, and a cylindrical peripheral wall section that extends from the main body base to a distal end side, the knob main body being provided in a given position in a peripheral direction of the peripheral wall section with a slit that extends from a distal end of the peripheral wall section to the main body base; a light guide member including an incident section having an incident surface for lights, and a light emitting section that extends along the slit to be fitted into the slit from the incident section, a surface of the incident section being adapted to emit lights when lights enter the incident section through the incident surface; and a pressure member for pinching a part of the incident section between the main body base and the pressure member along a longitudinal direction of the slit without covering the incident surface and for preventing a relative movement between the knob main body and the light guide member in the longitudinal direction of the slit when the light emitting section is fitted into the slit. The light emitting section includes a display portion that is fitted into the slit and has an exposed surface exposed outward from the knob main body through a whole length of the slit, and latching projections that are disposed inside the display portion in a radial direction of the peripheral wall section and protrudes outward from both sides in a width direction of the slit over the display portion. The peripheral wall section includes a pair of slit peripheral edges that are opposed to each other to define the slit, and holding portions that are provided inside the slit peripheral edges in the radial direction of the peripheral wall section and pinch the latching projections between the holding portions and the slit peripheral edges from both sides in the radial direction of the peripheral wall section.

According to the above structure, it is possible to settle the light guide member in the knob main body and to effect a sufficient display effect after the light guide member is attached to the knob main body, even if the peripheral wall section of the knob main body is thin.

That is, even if the peripheral wall section and the light guide member to be attached to the peripheral wall section are thin, it is possible to pinch the display portion on the light guide member in the width direction of the slit by utilizing the pair of slit peripheral edges of the knob main body and it is possible to stably attach the light guide member to the knob main body by pinching the latching projections on the light guide member from the radial direction of the peripheral wall section.

Specifically, the pair of slit peripheral edges pinch the display portion from both sides of the slits in the width direction, and the slit peripheral edges and the holding portions disposed inside the slit peripheral edges in the radial direction of the slit peripheral edges pinch the latching projections from both sides in the radial direction of the slit peripheral edges. Consequently, it is possible to effectively prevent the light emitting section from fluttering in the slit in the width direction and in the radial direction. Under this condition, since the main body base and pressure member pinch a part of the incident portion in the longitudinal direction of the slit, it is possible to prevent the incident portion from sliding in the main body base in the longitudinal direction of the slit. Thus, it is possible to prevent a relative movement between the knob main body and the light guide member in the longitudinal direction of the slit, thereby settling the light guide member in the knob main body. The latching projections 35 are pinched at the rear side of the slit peripheral edges. When the rotary knob is mounted on the operation panel, the exposed surface on the display portion of the light emitting section can be exposed outward through the whole length of the slit at the peripheral wall section that protrudes from the front surface of the operation panel. Consequently, it is possible for the light emitting section to carry out a sufficient display effect by illuminating the whole exposed surface 34a by the lights from the light source to the incident surface while holding the light emitting section stably.

Preferably, in the rotary knob, the peripheral wall section includes a reinforcement portion that couples the holding portions to each other across the slit. The reinforcement portion is located on only an area inside a front surface of the panel when the rotary knob is mounted on the panel.

According to the above structure, since the reinforcement portion that couples the holding portions to each other across the slit is provided on the peripheral wall section, the knob main body in which the slit is provided in the peripheral wall section can be effectively reinforced. Furthermore, when the rotary knob is disposed to penetrate the operation panel from the inside, the reinforcement portion is formed in only an inner area from the front surface of the operation panel. When the exposed surface on the display portion emits the lights, the reinforcement portion hardly affects the light emitting action from the exposed surface at the front surface of the operation panel.

Preferably, the rotary knob further comprises a reflection member provided with a reflection surface at a position inside the light emitting section in the radial direction of the peripheral wall section and at a distal end side position from the reinforcement portion. The reflection surface is opposed to the light emitting section to reflect lights from the light emitting section when the display portion is fitted into the slit.

According to the above structure, when the rotary knob is mounted on the operation panel, in a portion of the rotary knob that protrudes from the operation panel, the lights that enter the rotary knob through the incident surface are guided from the light emitting section to the inside of the peripheral wall section in the radial direction and the lights are reflected on the reflection surface on the reflection member opposed to the light emitting section at the inside in the radial direction so as to be directed outward in the radial direction. Consequently, the exposed surface becomes brighter and this can achieve a sufficient display effect.

Preferably, in the rotary knob, the main body base is provided in an end surface opposite from the peripheral wall section at a position corresponding to the slit with a through-hole defined by an inner peripheral surface having a shape corresponding to an outer peripheral surface of the light emitting section when the light guide member is attached to the knob main body. The through-hole is adapted to pass the light emitting section in a longitudinal direction of the slit so that the display portion is fitted into the slit and the latching projections are fitted into a space between the slit peripheral edges and the holding portions corresponding to the slit peripheral edges. The light guide member is provided on the incident portion with a flange portion that widens outward from a periphery of the incident portion. A surface at a distal end side of the flange portion is formed into a configuration that extends along a peripheral edge around the through-hole in the end surface opposite from the peripheral wall section of the main body base. The pressure member pinches the flange portion between the pressure member and the main body base so that the pressure member presses the flange portion onto the end surface of said main body base opposite from the peripheral wall section.

According to the above structure, since the flange portion of the light guide member is pressed by the end surface of the main body base opposite from the peripheral wall section when the light guide member is attached to the knob main body, the distal end surface of the flange portion contact the peripheral edge around the through-hole in the end surface of the main body base opposite from the peripheral wall section, thereby settling the light guide member in the knob main body. That is, since the flange portion that widens in a direction perpendicular to or substantially perpendicular to the extending direction of the light emitting section is pressed by the end surface of the main body base opposite from the peripheral wall section base when the flange portion contact the end surface of the main body base opposite from the peripheral wall section through the whole peripheral length around the through-hole, it is possible to suitably prevent the distal end of the light emitting section from fluttering in the knob main body.

### UTILIZABLE POSSIBILITY IN INDUSTRY

As described above, the rotary knob of the present invention can be utilized as a rotary knob to be mounted an operation panel in a vehicle room. After the light guide member is attached to the knob main body, it is possible to stabilize the light guide member in the knob main body, thereby achieving a sufficient display effect.

1. A rotary knob that penetrates a panel from an inside of said panel and is rotatably mounted on said panel, comprising:
a knob main body including a main body base disposed inside said panel when said rotary knob is mounted on said panel, and a cylindrical peripheral wall section that extends from said main body base to a distal end side, said knob main body being provided in a given position in a peripheral direction of said peripheral wall section with a slit that extends from a distal end of said peripheral wall section to said main body base;
a light guide member including an incident section having an incident surface for light, and a light emitting section that extends along said slit to be fitted into said slit from said incident section, a surface of said incident section being adapted to emit light when light enter said incident section through said incident surface; and
a pressure member for pinching a part of said incident section between said main body base and said pressure member along a longitudinal direction of said slit without covering said incident surface and for preventing a relative movement between said knob main body and said light guide member in said longitudinal direction of said slit when said light emitting section is fitted into said slit;
wherein said light emitting section includes a display portion that is fitted into said slit and has an exposed surface exposed outward from said knob main body through a whole length of said slit, and latching projections that are disposed inside said display portion in a radial direction of said peripheral wall section and protrude outward from both sides in a width direction of said slit over said display portion; and
wherein said peripheral wall section includes a pair of slit peripheral edges that are opposed to each other to define said slit, and holding portions that are provided inside said slit peripheral edges in said radial direction of said peripheral wall section and pinch said latching projections between said holding portions and said slit peripheral edges from both sides in said radial direction of said peripheral wall section.

2. A rotary knob according to Claim I, wherein said peripheral wall section includes a reinforcement portion that couples said holding portions to each other across said slit, said reinforcement portion is located on only an area inside a front surface of said panel when said rotary knob is mounted on said panel.

3. A rotary knob according to claim 2, further comprising a reflection member provided with a reflection surface at a position inside said light emitting section in said radial direction of said peripheral wall section and at a distal end side position from said reinforcement portion, said reflection surface being opposed to said light emitting section to reflect light from said light emitting section when said display portion is fitted into said slit.

4. A rotary knob according to claim 1, wherein said main body base is provided in an end surface opposite from said peripheral wall section at a position corresponding to said slit with a through-hole defined by an inner peripheral surface having a shape corresponding to an outer peripheral surface of said light emitting section when said light guide member is attached to said knob main body, said through-hole being adapted to pass said light emitting section in a longitudinal direction of said slit so that said display portion is fitted into said slit and said latching projections are fitted into a space between said slit peripheral edges and said holding portions corresponding to said slit peripheral edges;
wherein said light guide member is provided on said incident portion with a flange portion that widens outward from a periphery of said incident portion, a surface at a distal end side of said flange portion is formed into a configuration that extends along a peripheral edge around said through-hole in said end surface opposite from said peripheral wall section of said main body base; and
wherein said pressure member pinches said flange portion between said pressure member and said main body base so that said pressure member presses said flange portion onto said end surface of said main body base opposite from said peripheral wall section.

5. A rotary knob according to claim 3, wherein the reflection member includes a front end and a cylindrical fitting section that is formed into a cylindrical shape that is fitted into the peripheral wall section of the knob main body.

6. A rotary knob according to claim 1, wherein the peripheral wall section is formed into a cylindrical configuration having a constant diameter in the direction of the central axis.

7. A rotary knob according to claim 1, wherein the peripheral wall section is formed into a cylindrical configuration having a peripheral surface of a circular truncated cone that reduces a diameter toward the distal end.
